(19) United States
(12) Patent Application Publication
(10) Pub. No.: US 2003/0142800 A1
(43) Pub. Date: Jul. 31, 2003

(54) Method and system for voting by telephone

(76) Inventors: Kent Paschal, New York, NY (US); Lia Paschal, New York, NY (US)

Correspondence Address: Cooper & Dunham LLP, 1185 Avenue of the Americas, New York, NY, 10036, US

(21) Appl. No.: 10/059,090

(22) Filed: Jan. 28, 2002

(51) Int. Cl. H04M 11/00

(52) U.S. Cl. 379/92.02; 379/93.03

(57) ABSTRACT

A method and system for voting by telephone utilizing multiple layers of security, including a first security method of receiving a telephone call from a caller, receiving an identification number entered by the caller and comparing the entered identification number to a plurality of stored identification numbers. A second security level includes comparing a telephone number from which the call originates to a stored telephone number. A third security level includes entering a second identification number and comparing the second identification number to a second stored identification number. A fourth security level includes entering a voice sample and comparing the entered voice sample to a stored voice sample. The method and system are both scalable and anonymous, adaptable to vastly different populations and provide anonymity for voters

### FIELD OF THE DISCLOSURE

The present disclosure relates to a method and system of voting by telephone. More specifically, the disclosure relates to a method and system of voting by telephone utilizing multiple layers of security to confirm voter identity and that each voter utilizing the system may vote only once.

### BACKGROUND OF THE DISCLOSURE

The contemporary method of voting in a voting booth at a polling place is inconvenient and inaccurate. In some states, for example, paper ballots are used where voters are asked to select their candidates by punching a hole associated with the desired candidate. This method however, creates several problems.

The presentation of the ballot to the voter is often confusing. For example, in the recent national presidential election, it became clear that ballots are not always understood, sometimes causing voters to unintentionally vote for the wrong candidate. In addition, the voter is usually unaware that they have voted incorrectly because there is no way for the voter to find out which candidate they voted for.

One solution to this problem is to provide a system by which individuals can vote by telephone. Telephone voting allows voters to hear the names of the candidates, which is clearer than a confusing ballot. Such systems are already used in informal polls conducted, for example, by television programs to gather viewer opinions on news stories, court cases, etc. Commonly, viewers call one telephone number to cast a vote for one opinion or a second phone number to cast a vote for a differing opinion. The use of telephone voting thus allows viewers to interact with a TV program and provides them with a voice to be heard. One drawback of these telephone voting systems is that viewers can call and vote for their choice many times, making the results somewhat unreliable. This shortcoming is less important in the context of informal opinion polls, however, multiple votes cast by a single voter is unacceptable in a local, statewide or national political election.

In addition, these prior art voting systems place no restriction on whom may vote. While these systems are sufficient for conducting consumer surveys and opinion polls, it is unacceptable to allow a New York resident, for example, to vote in a New Jersey State election. In other words, the prior art systems lack voter identification measures to ensure that only qualified or registered voters vote.

More secure telephone voting systems have been developed. These systems are adapted primarily for use by private organizations such as unions to elect leaders or corporations to allow shareholders to vote by proxy. In this setting, security is more important because there are real consequences to the outcome of the vote. In such situations, the voting population is identified prior to the election and provided with a personal identification number (or PIN) of some sort. Prior to voting by telephone, the voter is required to enter their PIN which is matched to a list of PIN's corresponding to eligible voters. If no match is found, the voter is not allowed to vote. If the PIN matches that of an eligible voter, the caller is permitted to cast his or her vote.

The telephone voting systems utilizing identification numbers provide increased security, but are still subject to fraud. Anyone who obtains the PIN of the voter can vote as that individual. Usually, the identification numbers are sent via mail to the voters, and thus it is not uncommon for this material to become lost or stolen. In addition, it may be possible for someone to guess another voter's PIN. Given the importance of the right to vote in political elections, it is unacceptable to allow voters to lose their vote because of the unscrupulous activities of others.

Some prior art telephone voting systems have been developed to minimize the occurrence of voter identification theft. An early example of such a telephone voting system can be found in U.S. Pat. No. 3,644,675 to Watlington. In Watlington, a voter calls a predetermined phone number and enters their own telephone number. The voting system calls the voter back using the entered telephone number. The voting system may also compare the entered number to a list of numbers stored in memory for identification purposes. While the system described in Watlington decreases the risk of voter fraud, several problems persist. One problem arises when the voting system calls the voter back, but the voter has received an intervening telephone call from another individual. Even where no intervening telephone call is received by the voter, there is no guarantee that the voter will actually answer the return telephone call. Another individual at the same phone number may answer the telephone and vote on the voter's behalf. If the voter does not leave the residence while waiting for the call back, the voter is inconvenienced by having to wait for the voting system to call the voter back. At peak voting times such as before or after regular business hours, this wait could be substantial and annoying.

It is therefore desirable to provide a method and system for voting by telephone in which voters are afforded an accurate and secure opportunity to cast their vote while minimizing the opportunity for voter fraud.

### SUMMARY OF THE DISCLOSURE

A method for voting by telephone utilizing multiple layers of security includes the steps of receiving a telephone call from a caller; receiving an identification number entered by the caller; comparing the entered identification number to a plurality of stored identification numbers; comparing the telephone number from which the call originates, that is a caller telephone number, to a stored telephone number; and recording a vote entered by the caller if the entered identification number matches one of the plurality of stored identification numbers, the caller telephone number matches the stored telephone number and the entered identification number and the stored telephone number are associated. The method may further include updating voter identification information associated with the entered identification number after the vote is recorded such that a subsequent caller entering the same identification number received is prevented from voting. The plurality of stored identification numbers and associated voter identification information may be retrieved from a first storage device. The method may include receiving the caller telephone number from a caller identification system.

The caller may employ one of voice, touch tone and a handicap accessible device to record a vote.

The method may further include receiving a second identification number entered by the caller; retrieving a second stored identification number associated with the entered second identification number; and comparing the entered second identification number to the second stored identification number, wherein the vote of the caller is recorded if the entered identification number received matches one of the plurality of stored identification numbers, the entered second identification number matches the second stored identification number, the caller telephone number matches the stored telephone number and the entered identification number, the second stored identification number and the stored telephone number are associated.

If the entered identification number received does not match one of the plurality of stored identification numbers, the caller may be requested to re-enter the identification number.

If the entered second identification number received does not match the second stored identification number, the caller may be requested to re-enter the second identification number.

The method may further include receiving a caller voice sample from the caller; comparing the caller voice sample of the caller to a stored voice sample, wherein the vote of the caller is recorded if the entered identification number received matches one of the plurality of stored identification numbers, the caller telephone number matches the stored telephone number, the caller voice sample matches the stored voice sample and the entered identification number, the stored telephone number and the stored voice sample are associated.

The method may further include receiving a caller voice sample from a caller; comparing the caller voice sample of the caller to a stored voice sample, wherein the vote of the caller is recorded if the entered identification number received matches one of the plurality of stored identification numbers, the entered second identification number received matches the second stored identification number, the caller telephone number matches the stored telephone number, the caller voice sample matches the stored voice sample and the entered identification number, the stored telephone number, the second identification number and the stored voice sample are associated.

The step of receiving an incoming telephone may include receiving an incoming call from a caller modem connected to a caller computer. The step of receiving an incoming call from a caller modem may include decoding a voice signal from the caller modem entered by the caller using a microphone connected to the caller computer.

The vote of the caller may be recorded anonymously such that no identity is associated with the vote.

The vote of the caller may be repeated and the caller may confirm the vote.

A system for voting by telephone utilizing multiple security devices includes a call receiving device adapted to receive an incoming telephone call from a caller; an identification number receiving device adapted to receive an identification number entered by the caller; an identification number comparing device adapted to compare the entered identification number to a plurality of stored identification numbers; a telephone number comparing device adapted to compare a caller telephone number from which the call originates with a stored telephone number; and a voting device adapted to record a vote of the caller if the entered identification number matches one of the plurality of stored identification numbers, the caller telephone number matches the stored telephone number and the identification number and the stored telephone number are associated.

The system may include a voter identification updating device adapted to update voter identification information after the vote of the caller is recorded by the voting device such that a subsequent caller entering the voter information associated with the caller is prevented from voting.

The identification number comparing device may include a storage device adapted to store the plurality of stored identification numbers and associated voter identification information.

The caller identification device may include a caller identification system of a public telephone company to which the telephone voting system is connected.

The voting device may include a speech recognition device adapted to interpret a voice entry of the caller. The voting device may include a touch tone signal interpreting device adapted to interpret a touch tone signal input by the caller.

The first security device may include a second identification number device adapted to receive a second identification number entered by the caller; and a second identification number matching device adapted to match the entered second identification number with a second stored identification number; wherein the voting device records the vote of the caller if the entered identification number matches one of the plurality of stored identification numbers, the second identification number matches the second stored identification number, the caller telephone number matches the stored telephone number and the entered identification number, the second identification number and the stored telephone number are associated.

If the entered identification number does not match one of the plurality of stored identification numbers, the caller may be requested to re-enter the identification number.

If the entered second identification number does not match the second stored identification number, the caller may be requested to re-enter the second identification number.

The system may include a voice sample receiving device adapted to receive a caller voice sample from the caller; a voice sample comparing device adapted to compare a caller voice sample to a stored voice sample; wherein the voting device records the vote of the caller if the entered identification number matches one of the plurality of stored identification numbers, the caller telephone number matches the stored telephone number, the caller voice sample matches the stored voice sample and the identification number, the stored telephone number and the stored voice sample are associated.

The system may include a voice sample comparing device adapted to compare a caller voice sample from the caller to a stored voice sample; wherein the voting device records the vote of the caller if the entered identification number matches one of the plurality of stored identification numbers, the entered second identification number matches the second stored identification number, the caller telephone number matches the stored telephone number, the caller voice sample matches the stored voice sample and the entered identification number, the second stored identification number, the stored telephone number and the stored voice sample are associated.

The call receiving device may include a system modem adapted to receive a telephone call from a caller modem connected to a caller computer. The call receiving device may include a decoding device adapted to decode a voice signal from the caller modem input by the caller using a microphone connected to the caller computer.

The voting device may record the vote of the voter anonymously such that no identity is associated with the vote.

The voting device may repeat the vote to the caller and the caller may confirm the vote.

A method of voting by telephone utilizing multiple layers of security includes receiving a telephone call from a caller; comparing an entered identification number from the caller to a plurality of stored identification numbers; performing at least one of comparing an entered second identification number to a plurality of stored second identification numbers; comparing a caller telephone number to a plurality of stored telephone numbers; comparing a voice sample entered by the caller to a plurality of stored voice samples; and recording a vote of the caller after (1) the entered identification number is matched to one of the plurality of stored identification numbers, (2) at least one of the entered second identification number is matched to one of the stored second identification numbers, the caller telephone number is matched to one of the stored telephone numbers and the voice sample is matched to one of the plurality of stored voice sample and (3) the entered identification number is associated with at least one of the one stored second identification number, the one stored telephone number and the one stored voice sample.

A system of voting by telephone utilizing multiple security levels includes a call receiving device adapted to receive a telephone call from a caller; an identification number comparing device adapted to compare an entered identification number entered by the caller with a plurality of stored identification numbers; one of: a second identification number comparing device adapted to compare an entered second identification number entered by the caller to a plurality of stored second identification numbers; a caller telephone number comparing device adapted to compare a caller telephone number to a plurality of stored telephone numbers; a voice sample comparing device adapted to compare a voice sample provided by the caller to a plurality of stored voice samples; and a voting device adapted to record a vote of the caller after (1) the entered identification number is matched to one of the plurality of stored identification numbers, (2) at least one of the entered second identification number is matched to one of the plurality of stored second identification numbers, the caller telephone number matches one of the plurality of stored telephone numbers and the voice sample matches one of the plurality of stored telephone numbers and (3) the entered identification number is associated with at least one of the one stored second identification number, the one stored telephone number and the one stored voice sample.

A closed telephone voting system utilizing multiple security levels includes an input device adapted to allow a caller to input information; at least one of: an identification number comparing device adapted to compare an entered identification number entered by the caller to a plurality of stored identification numbers; a second identification number comparing device adapted to compare an entered second identification number to a plurality of stored second identification numbers; a voice sample comparing device adapted to compare a voice sample provided by the caller to a plurality of stored voice samples; and a voting device adapted to record a vote of the caller after at least one of (1) the entered identification number is matched to one of the plurality of stored identification numbers, (2) the entered second identification number is matched to one of the plurality of stored identification numbers and (3) the voice sample is matched to one of the plurality of stored voice samples.

A telephone voting system utilizing multiple security levels includes a telephone call receiving device adapted to receive a telephone call of a caller; at least one of: an identification number comparing device adapted to compare an entered identification number entered by the caller to a plurality of stored identification numbers; a second identification number comparing device adapted to compare an entered second identification number to a plurality of stored second identification numbers; a caller telephone number comparing device adapted to compare a caller telephone number to a plurality of stored telephone numbers; a voice sample comparing device adapted compare a voice sample provided by the caller to a plurality of stored voice samples; and a voting device adapted to record a vote of the caller after at least one of (1) the entered identification number is matched to one of the plurality of stored identification numbers, (2) the entered second identification number is matched to one of the plurality of stored identification numbers, (3) the caller telephone number is matched to one of the plurality of stored telephone numbers and (4) the voice sample is matched to one of the plurality of stored voice samples.

A program storage medium, readable by a machine, embodying a program of instructions executable by the machine to perform method steps for voting by telephone using multiple security levels is provided. The method steps may include receiving a telephone call from a caller; receiving an identification number entered by the caller; comparing the entered identification number to a plurality of stored identification numbers; comparing the telephone number from which the call originates, that is a caller telephone number, to a stored telephone number; and recording a vote entered by the caller if the entered identification number matches one of the plurality of stored identification numbers, the caller telephone number matches the stored telephone number and the entered identification number and the stored telephone number are associated.

A computer system may include a processor; and a program storage device readable by the computer system, embodying a program of instructions executable by the processor to perform method steps for voting by telephone, the method steps including: receiving a telephone call from a caller; receiving an identification number entered by the caller; comparing the entered identification number to a plurality of stored identification numbers; comparing the telephone number from which the call originates, that is a caller telephone number, to a stored telephone number; and recording a vote entered by the caller if the entered identification number matches one of the plurality of stored identification numbers, the caller telephone number matches the stored telephone number and the entered identification number and the stored telephone number are associated.

### BRIEF DESCRIPTION OF DRAWINGS

The features of the present disclosure can be more readily obtained from the following detailed description with reference to the accompanying drawings, wherein:

FIG. 1 shows a block diagram corresponding to a computer system that may embody the methods described in the present disclosure;

FIG. 1A illustrates processes into which a method of voting by telephone may be implemented according to an embodiment of the present disclosure;

FIG. 2 shows a block diagram illustrating a methodology for voting by telephone according to an embodiment of the present disclosure;

FIG. 2A shows a more detailed block diagram illustrating a portion of the methodology for voting by telephone of FIG. 2;

FIG. 3 shows a flow chart corresponding to a first security method, according to an embodiment of the present disclosure;

FIG. 4 shows a flow chart corresponding to a second security method, according to an embodiment of the present disclosure;

FIG. 5 shows a flow chart corresponding to another security method according to an embodiment of the present disclosure; and

FIG. 6 shows a flow chart corresponding to another security method according to an embodiment of the present disclosure.

FIG. 7 shows a high level diagram illustrating a system for voting by telephone according to an embodiment of the present disclosure.

### DETAILED DESCRIPTION

In describing the embodiments of the present disclosure, specific terminology is employed for sake of clarity. However, the present disclosure is not intended to be limited to the specific terminology selected and it is to be understood that each specific element includes all technical equivalents which operate in a similar manner. For example, the word “device” as used herein and in the claims is not limited to a hardware device, but is intended to include code or modules of code adapted to operate in a similar manner.

A methodology, in accordance with one embodiment of the present disclosure, may include answering an incoming telephone call from a caller, who is then requested to enter an identification number. After the caller enters an identification number, for example, the system may retrieve information associated with the entered identification number, or the system may retrieve this information at a different time. The retrieved information may include, for example, a stored telephone number, name, address and voice sample (a stored voice sample). In one embodiment, the stored telephone number associated with the entered identification number is compared to a caller telephone number from which the caller is calling (available, for example, using caller ID technology, which is known in the art). If there is a match, the caller is permitted to vote, after which the caller's identification number is removed from a list of identification numbers corresponding to persons who may cast a vote.

In another embodiment, the caller is prompted to enter a voice sample, for example, by speaking his or her name or a control word. The entered voice sample or caller voice sample is compared to a plurality of stored voice samples provided by voters upon registering to vote. If the entered voice sample matches one of the plurality of stored voice samples provided at voter registration, the stored telephone number matches the telephone number from which the call originates and the entered identification number matches one of the plurality of identification numbers, the system determines if the stored voice sample, the stored telephone number and the identification number are associated, meaning associated with one registered voter. If there is such an association, the caller is permitted to vote. Again, once the vote is recorded, the entered identification number is removed from the list of identification numbers corresponding to qualified voters who have not cast a vote.

The methodology may be implemented in the form of a software application running on a computer system such as a mainframe, minicomputer, personal computer (PC), handheld computer, server, etc. The computer system may be linked to a database. The link may be, for example, via a direct link such as a direct hard wire or wireless connection, via a network connection such as a local area network, or via the Internet. The computer system may also be linked to the public telephone network.

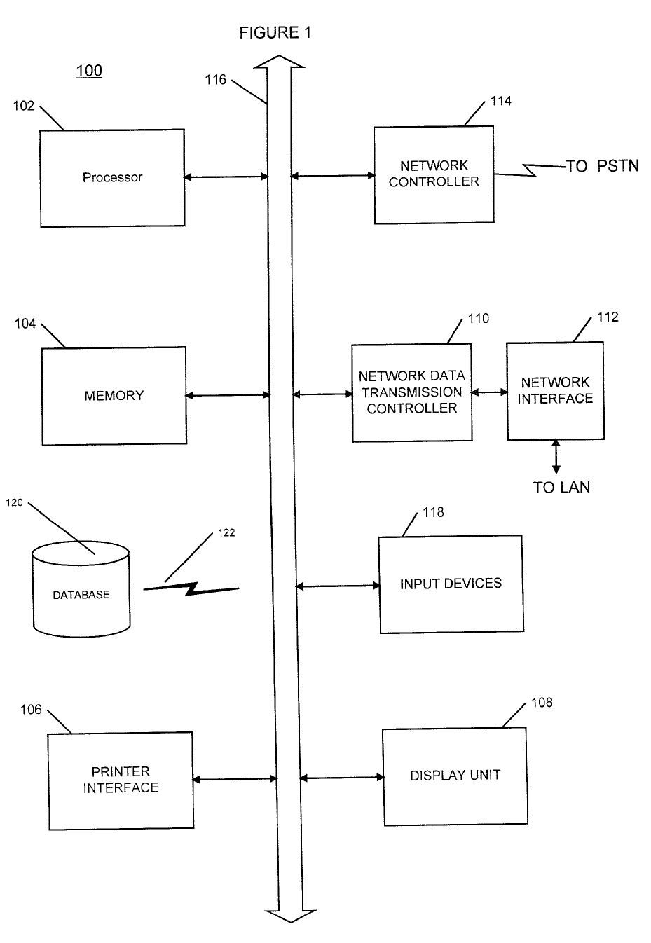

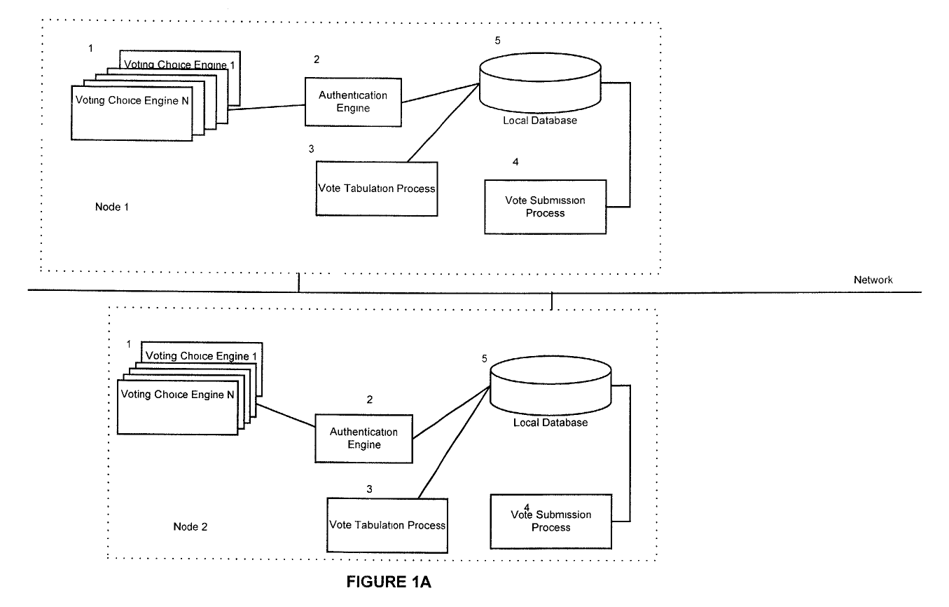

An example of a computer system capable of implementing the present system and method is shown in FIG. 1. The computer system referred to generally as system 100 may include a processor 102, memory 104, an optional printer interface 106 and display unit 108, a network data transmission controller 110, a network interface 112, a network controller 114, an internal bus 116 and one or more input devices 118 such as, for example, a keyboard, mouse, etc. As shown, the system 100 may be connected to a database 120 via a link 122.

FIG. 1A generally illustrates some of the processes into which the method of voting by telephone may be divided. Multiple nodes, representing voting districts or polling stations in a voting district, for example, may be connected to a common network. At each node, the voting choice engine 1 cycles through all candidates running for a political office. A voting choice engine may be provided for each open political office such that there may be N (where N is an integer greater or equal to 1) voting choice engines. The authentication engine 2 generally implements the processes for authenticating the identity of a potential voter. Individual processes for authentication are explained in further detail herein below. The vote tabulation process 3 refers to a process in which the votes of an individual voter are added to or tabulated with all votes cast at the polling station. The vote submission process 4 relates to steps for writing the particular voter choices into the database 5 or any other memory device.

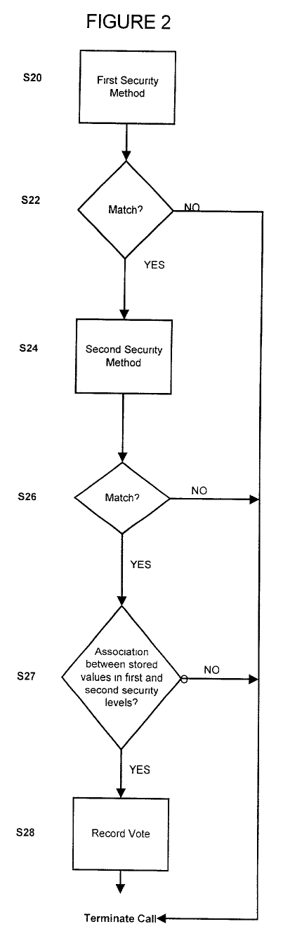

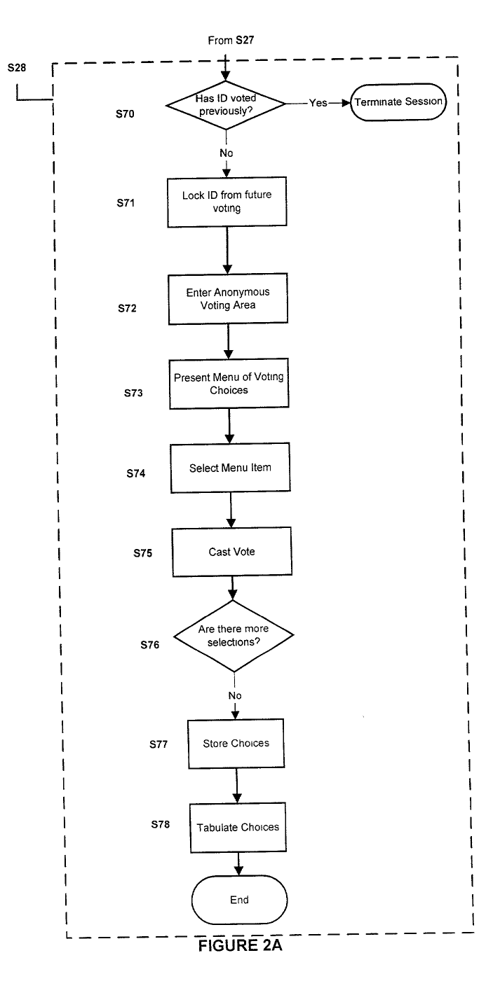

The methods of the present disclosure provide for voting by telephone utilizing multiple tiers or levels of security. The methodology is described at a high schematic level generally with reference to FIG. 2. A first level of security is implemented in a first security method at step S20. For example, at step S20, a caller calls into the system and enters his or her identification number. If the entered identification number matches one of a plurality of stored identification numbers, the first security level is passed (a “Yes” at step S22). A second level of security is implemented at step S24 by applying a second security method. For example, at step S24, a caller telephone number is generated using caller ID. The caller telephone number is then compared to a stored telephone number. If the caller telephone number matches the stored telephone number associated with the entered identification number, the second layer of security is passed (a “Yes” step S26). At step S28, if the entered identification number matches a stored identification number and the caller telephone number matches the stored telephone number associated with the entered identification number, in other words a “Yes” at both steps S22 and S26, the caller is permitted to cast his or her vote, which is recorded for tabulation. If the first security level is not passed (a “No” at step S22) the call may be terminated, or the caller may be provided another opportunity to enter the identification number which will be discussed in detail below. If the caller ID telephone number does not match the stored telephone number (a “No” at step S26), the call is terminated.

After this initial identification takes place, the caller is permitted to vote at step S28. FIG. 2A provides a more detailed exemplary illustration of the caller voting in step S28. A determination is made as to whether the identified caller has voted previously as shown in step S70 of FIG. 2A. If the voter has voted previously (Yes, step S70) the call is terminated so that the voter is not allowed to vote twice in the same election. If the caller has not previously voted (No, step S70) a notation is made to lock the caller identification out for future voting at step S71. At step S72, the caller accesses an anonymous voting area. At step S73, the caller is presented with options to be voted on. At step S74, the caller selects a menu representing all the candidates running for a political office, such as mayor, for example. At step S75, the caller casts their vote, selecting one of the candidates for mayor, for example. At step S76, a determination is made as to whether any other selctions are to be made, that is whether any other political offices or political questions are to be decided by the electorate. If more selections are to be made (Yes, step S76) the method returns to step S73 and the caller is presented with a new menu of choices. At step S77, where no more selections need to be made (No, at step S76) all selections made by the caller are stored. At step S78, all of the votes are tabulated, that is added to all votes cast by all voters.

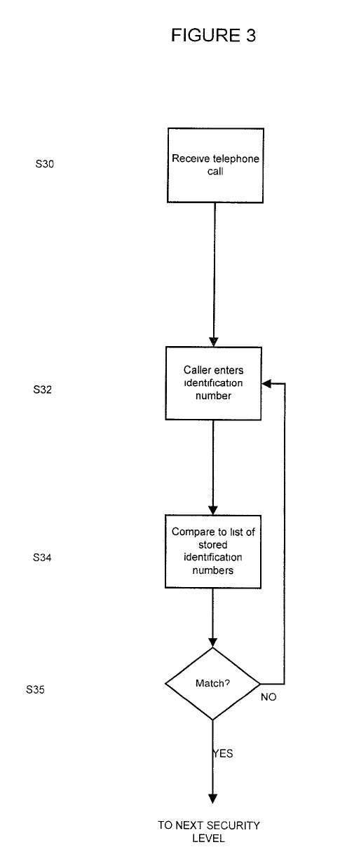

The first security method (of step S20), according to one embodiment, is explained in detail with reference to FIG. 3. At step S30, the system receives an incoming call made by a caller, who dials a predetermined telephone number. This predetermined telephone number should preferably be sent to the caller along with a unique identification number assigned to each qualified voter prior to the election. At step S32, the caller enters his or her identification number using an interface such as the keypad of the telephone. Alternatively, the caller may speak the identification number. Speech recognition technology may be utilized in order to interpret the caller's spoken identification number. The identification number may be entered via an identity card passed through a card reader which will be described in more detail below. At step S34, the entered identification number is compared to a plurality of stored identification numbers. Voter identification information associated with each stored identification number may be stored with the identification numbers in a storage device or simply associated with the identification number. When the entered identification number matches one of the plurality of stored identification numbers, the potential voter has passed the first level of security. If the entered identification number does not match one of the plurality of stored identification numbers (a “No” at step S35), the call may be terminated. Alternatively, the caller may be given another opportunity to enter his or her identification number. This feature is illustrated by the arrow between steps S35 and S32 in FIG. 3. The caller may be given more than one opportunity to re-enter his or her identification number, however, there should be a limit on the number of times a caller may re-enter their identification number to reduce the probability of a caller guessing the identification number of another caller.

The identification number may be a currently existing voter registration number, for example. Using voter registration numbers is particularly useful because databases which include voter registration numbers and associated voter identification information already exist. The voter identification information in such databases commonly includes the voter name, address and telephone number. Therefore, there would be little or no cost in integrating these existing databases into the methodology described and claimed herein.

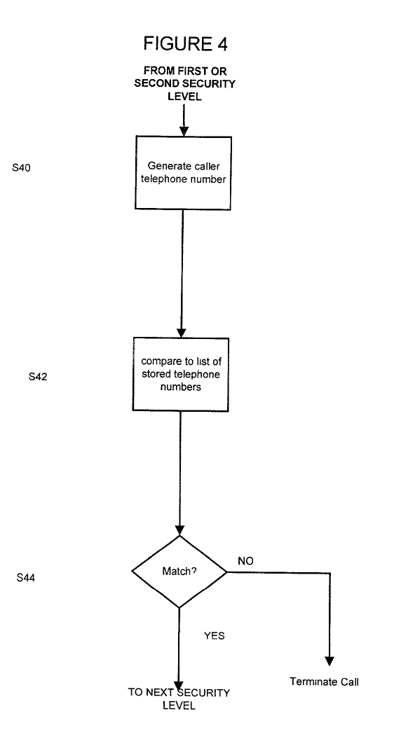

The second security method (of step S24), according to one embodiment, for example, is explained with reference to FIG. 4. At step S40, a caller telephone number, in other words, the telephone number from which the caller is calling, may be obtained using a caller identification system such as caller ID. At step S42, a stored telephone number associated with the identification number entered in step S20 and included in the voter identification information is retrieved. At step S44, the caller telephone number is compared to the stored telephone number. If the caller telephone number matches the stored telephone number (a “Yes” at step S44), the caller passes the second security method or second level of security. If the caller telephone number does not match the stored telephone number, the call may be terminated by the system.

The caller identification system utilized in the second security method may be a proprietary caller identification system or the caller identification system known as caller ID.

As noted above, the caller may enter their identification number by voice, similarly, the caller may vote by voice (step S28 of FIG. 2). Speech recognition technology may be employed to interpret the voice entry of the caller. That is, the voice entry of the caller is interpreted to determine what the caller said. The caller may also cast their vote by touch tone signals entered using the key pad of the telephone. The methodology of the present disclosure accommodates handicap accessible devices as well. The caller may be given the option of having the entire ballot read over the phone prior to casting a vote, or may opt to simply enter choices sequentially in accordance with a sample ballot sent to the caller prior to the election. In addition, the caller may be provided with a foreign language option in which all prompts are provided to the voter in a foreign language. Preferably, the caller will have the opportunity to confirm each vote after his or her selection is repeated back to the caller over the telephone.

It should be noted that once the caller passes through the security levels of the system, the vote of the voter is anonymous. The vote is counted, but remains unassociated with any specific voter. In addition, while a notation that a specific caller has voted is made to prevent the caller from voting again, no record is made as to how the voter voted.

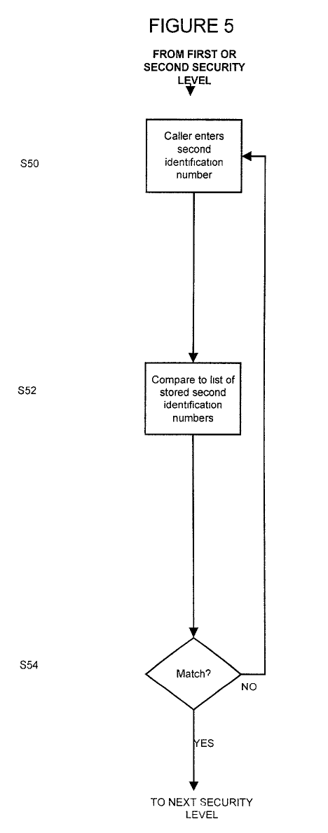

According to another embodiment, a third security method or level may be provided and is explained with reference to FIG. 5. This third level of security is preferably implemented as part of step S20 of FIG. 2, but may be implemented separately as well. If the first identification number entered by the caller matches one of a plurality of identification numbers (see FIG. 3), the caller may enter a second identification number at step S50. The second identification number may be entered by touch tone, voice or identity card, for example, as described above with relation to the identification number. At step S52, the entered second identification number is compared to a second stored identification number associated with the entered identification number. If the entered second identification number matches the second stored identification number (a “Yes” at step S54), the caller passes this level of security and the method may proceed to the second security method of step S24 as described above. If the entered second identification number does not match the second stored identification number (a “No” at step S54), the call may be terminated.

The second identification number may be the caller's social security number, or a portion of the caller's social security number, for example. The second identification number must be communicated to the caller prior to the election but not at the same time as the identification number, reducing the probability of voter fraud. Using social security numbers (or a portion thereof) as second identification numbers is particularly useful since the actual number itself need not be printed and sent to the potential callers. Potential callers can simply be told to use their social security number as their second identification number, providing an additional layer of security. Use of social security numbers is particularly useful when the caller's voter registration number is utilized as the identification number. Currently existing databases storing voter registration numbers and corresponding voter identification information commonly include corresponding social security numbers of the voters.

If the entered second identification number does not match the second voter identification number (a “No” at step S54) the caller may be given an opportunity to re-enter the second identification number. This feature is illustrated in FIG. 5 by the arrow between step S54 and S50. Although the caller may be provided with more than one opportunity to re-enter their second identification number, the number of re-entries should be limited for security reasons.

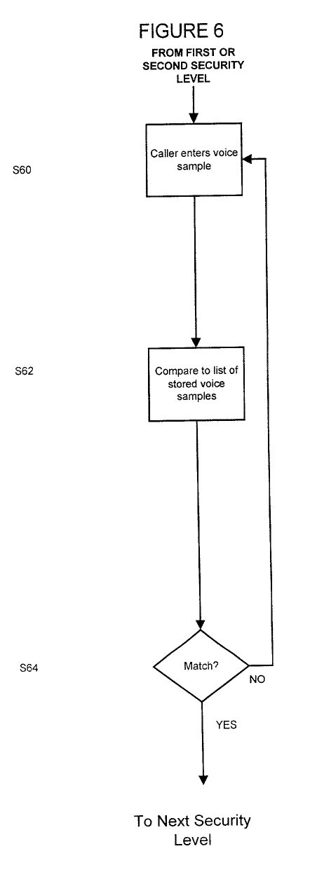

According to another embodiment, a fourth security method or level may be utilized. This fourth method, known in the art as speaker identification, may be implemented with any of the other three security levels described herein. Further, these security levels may be implemented in any order. Speaker identification allows a speaker to be identified by comparing the speakers' unique voice characteristics to a known speech sample. If the speaker's voice characteristics are sufficiently similar to the known sample, the speaker is identified as the same person who provided the sample. The fourth security method is described with reference to FIG. 6. At step S60, a voice sample, or a caller voice sample is received from the caller. This voice sample may be received at any point prior to step S28 of FIG. 2, in which the caller casts his or her vote. At step S62, the caller voice sample is compared to a plurality of stored voice samples associated with the entered identification number. The fourth security method is passed if the caller voice sample matches one of the plurality of stored voice samples (a “Yes” at step S64).

The stored voice sample may be collected and stored prior to the election. For example, with the caller's identification number may be instructions to call a second predetermined telephone number. Upon calling the second predetermined telephone number, the potential caller may be instructed to provide their identification number and a voice sample to be stored and associated with the identification number by the system. Alternatively, the caller may provide a voice sample upon registering to vote. For convenience in matching the entered voice sample with the stored voice sample, the stored voice sample provided prior to the election may be a predetermined word or phrase which the caller may be asked to repeat when attempting to vote. Use of this fourth security method prevents a potential voter from allowing another individual (such as a family member or member of the same household) to cast their vote for them. If the caller voice sample does not match the stored voice sample (a “No” at step S64), the caller may be given the opportunity to re-enter the voice sample. This feature is illustrated by the arrow between steps S64 and S60. The caller may be given the opportunity to re-enter the voice sample more than once but there should be a limit on the number of re-entries for security reasons. Alternatively, the call may be terminated if the caller voice sample does not match the stored voice sample (a “No” at step S64).

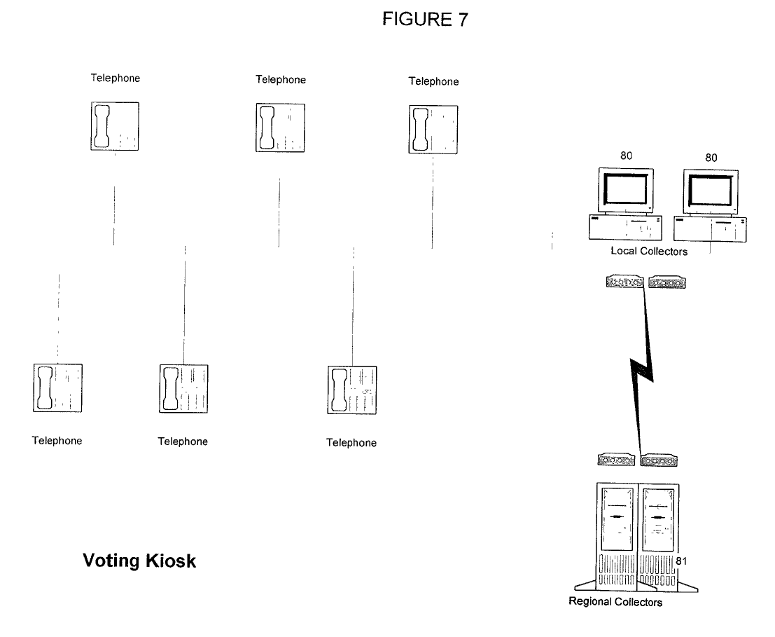

The present disclosure includes a closed system utilizing similar multiple levels of security. According to this embodiment, the closed system could be housed at a polling station, for example. Voters could go to the polling station and use a telephone to vote. The telephone would have a direct, dedicated connection to the telephone voting system. The caller would enter any of or all of their identification number, second identification number, or voice sample by phone either by touch tone, voice or identity card as described above. Once the required security levels are passed, the caller could vote as described above. Since the system is closed, there is no chance that an unauthorized user (i.e., a person not registered to vote or a hacker) could access the system and alter the results. In addition, since voters would still have to go to a polling station, all the current safeguards that are in place can be used in addition to the security levels of the system itself The polling center may include a local collector 80, or a plurality of local collectors, that is, systems for collecting votes of voters at the polling station. See FIG. 7, for example. These local collectors may be connected to regional collectors 81, for collecting vote totals from a plurality of local collectors 80 at various polling stations and combining the results. These local and regional collectors are illustrated in FIG. 7, for example.

As noted above, a caller may be provided with an identity card. The identity card may include a storage medium such as a magnetic strip or embedded electronic components that include the identification number and/or second identification number of the caller. Simply by swiping the card through a card reading device at the polling station, for example, the caller could clear those security levels which saves time improves efficiency. The identification numbers are preferably encoded in order to make counterfeiting identity cards difficult.

Where the telephone voting system is closed, the telephone voting system could be useful in recording absentee votes. For example, the system could be implemented at a U.S. embassy oversees, at an oversees military base, or onboard a navel vessel. Voters could then vote without the need to depend on the mail. The tabulated votes could be recorded or later divided by respective voting districts of the voters and the results could be sent electronically directly to the appropriate district. Thus, reliance on the mail is eliminated, along with the delay associated with tallying absentee ballots.

Several security methods have been discussed in the present disclosure. These security methods may be used in various combinations to accommodate the needs of a particular state, voting district or municipality. For example, certain voting districts or municipalities may not require the use of speaker identification as provided in the fourth security method and therefore may not want to absorb the added cost of including that security method. Further, voting may be authorized even when a caller fails to pass all security levels. For example, a caller may be allowed to vote after passing only two of threce levels of security if desired. The system is designed to provide a secure method for voting by telephone even when one or more of the security methods are not included.

Further, each voting district can have a separate telephone voting system that is scalable to each district's needs. These multiple voting systems may then report results to a central system to provide a final count. For example, the voting system in New York City would need to accommodate many thousands of voters. This system would preferably include several predetermined telephone numbers for each voting district by which the system is accessed. The telephone voting system would therefore be scalable according to the number of registered voters in each voting district. A voting district with a large number of voters would be accommodated as readily as a district in a rural area with very few voters by scaling the size of the system according to the number of registered voters in each particular voting district. In fact, a state, or municipality can be divided by zip code, or neighborhood for example. The telephone voting system in the area would tabulate results for the voting district or zip code and report them to a central tabulation system which would provide a final result. An additional advantage of using multiple systems is that the multiple systems could handle outside calls, while the final result is tabulated by the central tabulation system which is not directly contacted by callers, thus reducing the risk that the final results will be tampered with. Therefore, the telephone voting system is particularly useful in conjunction with application to absentee ballots. Whether multiple open systems or closed systems are utilized, the telephone voting system of the present disclosure provides numerous benefits. Where an open system is utilized, voters who are overseas or otherwise unavailable car simply call into their voting district's system to vote. In a closed system, the system would be physically located in a US embassy or military base, for example, and the results can be sent to respective voting districts electronically as described above.

The security levels described herein may be implemented in any order. That is, for example, a caller voice sample may be provided prior to entry of the identification number. In such a case, the caller voice sample may be compared to a plurality of stored voice samples. If the caller voice sample matches one of the plurality of stored voice samples, the level is passed and the method may continue to any one of the security levels disclosed herein. By associating the stored voice sample, the identification number, the stored telephone number and the second stored identification number, the security levels may be implemented in any order. Associated voter identification information (such as stored voice sample, identification number, second stored identification number and stored telephone number) denotes a single voter qualified to use the system.

While a telephone call referred to in the present disclosure generally refers to a telephone call from a human caller using a telephone handset, the disclosure is not limited to such an embodiment. A caller may cast their vote utilizing a computer (running a client based application of the methodology) and a modem, for example. The modem would dial into the voting system just like a human caller. The telephone call originates from the residence in which the computer and modem are located, so that the second security method (using caller ID technology) is operable. The caller computer may also include a microphone so that the caller will be able to provide a voice sample for use with the speaker identification or fourth security method described above, or to enable the caller to provide information to the system verbally. In this instance, the system decodes the voice signal sent from the caller modem and entered by the caller using a microphone connected to the caller's computer. When using the computer, voting options may be displayed to the caller on the caller's computer screen and the caller may enter their vote using a graphical user interface (GUI). Thus, the methodology of the present disclosure may receive a telephone call from a caller modem and computer.

The methodologies of the present disclosure may be conveniently implemented using one or more conventional general purpose digital computers and/or servers programmed according to the teachings of the present specification. Appropriate software can readily be prepared by programmers based on the teachings of the present disclosure. The present disclosure may also be implemented by the preparation of application specific integrated circuits or by interconnecting an appropriate network of conventional components or computers.

Numerous additional modifications and variations of the present disclosure are possible in view of the above-teachings. It is therefore to be understood that within the scope of the appended claims, the present invention may be practiced other than as specifically described herein.

What is claimed is:

1. A method for voting by telephone utilizing multiple layers of security, the method comprising:
(a) receiving a telephone call from a caller;
(b) receiving an identification number entered by the caller;
(c) comparing the entered identification number to a plurality of stored identification numbers;
(d) comparing a telephone number from which the call originates, that is a caller telephone number, to a stored telephone number; and
(e) recording a vote entered by the caller if the entered identification number matches one of the plurality of stored identification numbers in step (c), the caller telephone number matches the stored telephone number in step (d) and the entered identification number and the stored telephone number are associated.

2. The method according to claim 1, further comprising:
updating voter identification information associated with the entered identification number after the vote is recorded such that a subsequent caller entering the same identification number received in step (b) is prevented from voting.

3. The method of claim 1, wherein the plurality of stored identification numbers and associated voter identification information are retrieved from a first storage device.

4. The method of claim 1, further comprising:
receiving the caller telephone number from a caller identification system.

5. The method of claim 1, wherein the caller employs one of voice, touch tone and a handicap accessible device to record a vote.

6. The method of claim 1, further comprising:
(f) receiving a second identification number entered by the caller;
(g) retrieving a second stored identification number associated with the entered second identification number; and
(h) comparing the entered second identification number to the second stored identification number, wherein the vote of the caller is recorded if the entered identification number received in step (b) matches one of the plurality of stored identification numbers in step (c), the entered second identification number matches the second stored identification number in step (h), the caller telephone number matches the stored telephone number in step (d) and the entered identification number, the second stored identification number and the stored telephone number are associated.

7. The method according to claim 1, wherein if the entered identification number received in step (b) does not match one of the plurality of stored identification numbers, the caller is requested to re-enter the identification number.

8. The method of claim 6, wherein if the entered second identification number received in step (f) does not match the second stored identification number, the caller is requested to re-enter the second identification number.

9. The method of claim 1, further comprising
receiving a caller voice sample from the caller;
comparing the caller voice sample of the caller to a stored voice sample, wherein the vote of the caller is recorded if the entered identification number received in step (b) matches one of the plurality of stored identification numbers in step (c), the caller telephone number matches the stored telephone number in step (d), the caller voice sample matches the stored voice sample and the entered identification number, the stored telephone number and the stored voice sample are associated.

10. The method of claim 6, further comprising:
receiving a caller voice sample from a caller;
comparing the caller voice sample of the caller to a stored voice sample, wherein the vote of the caller is recorded if the entered identification number received in step (b) matches one of the plurality of stored identification numbers in step (c), the entered second identification number received in step (f) matches the second stored identification number in step (b), the caller telephone number matches the stored telephone number in step (d), the caller voice sample matches the stored voice sample and the entered identification number, the stored telephone number, the second identification number and the stored voice sample are associated.

11. The method of claim 1 wherein receiving an incoming telephone call comprises:
receiving an incoming call from a caller modem connected to a caller computer.

12. The method of claim 11, wherein the step of receiving an incoming call from a caller modem comprises:
decoding a voice signal from the caller modern entered by the caller using a microphone connected to the caller computer.

13. The method of claim 1, wherein the voted the caller is recorded anonymously such that no identity is associated with the vote.

14. The method of claim 1, wherein the vote of the caller is repeated and the caller confirms the vote.

15. A system for voting by telephone utilizing multiple security devices, the system comprising:
a call receiving device adapted to receive an incoming telephone call from a caller;
an identification number receiving device adapted to receive an identification number entered by the caller;
an identification number comparing device adapted to compare the entered identification number to a plurality of stored identification numbers;
a telephone number comparing device adapted to compare a caller telephone number from which the call originates with a stored telephone number; and
a voting device adapted to record a vote of the caller if the entered identification number matches one of the plurality of stored identification numbers, the caller telephone number matches the stored telephone number and the identification number and the stored telephone number are associated.

16. The system of claim 15, further comprising:
a voter identification updating device adapted to update voter identification information after the vote of the caller is recorded by the voting device such that a subsequent caller entering the voter information associated with the caller is prevented from voting.

17. The system of claim 15, wherein the identification number comparing device further comprises:
a storage device adapted to store the plurality of stored identification numbers and associated voter identification information.

18. The system of claim 15, wherein the caller identification device comprises:
a caller identification system of a public telephone company to which the telephone voting system is connected.

19. The system of claim 15, wherein the voting device comprises:
a speech recognition device adapted to interpret a voice entry of the caller.

20. The system of claim 15, wherein the voting device comprises:
a touch tone signal interpreting device adapted to interpret a touch tone signal input by the caller.

21. The system of claim 15, wherein the first security device further comprises:
a second identification number device adapted to receive a second identification number entered by the caller; and
a second identification number matching device adapted to match the entered second identification number with second stored identification number; wherein the voting device records the vote of the caller if the entered identification number matches one of the plurality of stored identification numbers, the second identification number matches the second stored identification number, the caller telephone number matches the stored telephone number and the entered identification number, the second identification number and the stored telephone number are associated.

22. The system of claim 15, wherein
if the entered identification number does not match one of the plurality of stored identification numbers, the caller is requested to re-enter the identification number.

23. The system of claim 21, wherein
if the entered second identification number does not match the second stored identification number, the caller is requested to re-enter the second identification number.

24. The system of claim 15 further comprising:
a voice sample receiving device adapted to receive a caller voice sample from the caller;
a voice sample comparing device adapted to compare the caller voice sample to a stored voice sample; wherein the voting device records the vote of the caller if the entered identification number matches one of the plurality of stored identification numbers, the caller telephone number matches the stored telephone number, the caller voice sample matches the stored voice sample and the identification number, the stored telephone number and the stored voice sample are associated.

25. The system of claim 21, further comprising:
a voice sample comparing device adapted to compare a caller voice sample from the caller to a stored voice sample; wherein the voting device records the vote of the caller if the entered identification number matches one of the plurality of stored identification numbers, the entered second identification number matches the second stored identification number, the caller telephone number matches the stored telephone number, the caller voice sample matches the stored voice sample and the entered identification number, the second stored identification number, the stored telephone number and the stored voice sample are associated.

26. The system according to claim 15, wherein the call receiving device comprises:
a system modem adapted to receive a telephone call from a caller modem connected to a caller computer.

27. The system according to claim 25, wherein the call receiving device comprises
a decoding device adapted to decode a voice signal from the caller modem input by the caller using a microphone connected to the caller computer.

28. The system of claim 15, wherein the voting device records the vote of the voter anonymously such that no identity is associated with the vote.

29. The system of claim 15, wherein the voting device repeats the vote to the caller and the caller confirms the vote.

30. A method of voting by telephone utilizing multiple layers of security comprising:
receiving a telephone call from a caller;
comparing an entered identification number from the caller to a plurality of stored identification numbers.
performing at least one of:
comparing an entered second identification number to a plurality of stored second identification numbers;
comparing a caller telephone number to a plurality of stored telephone numbers;
comparing a voice sample entered by the caller to a plurality of stored voice samples; and
recording a vote of the caller after (1) the entered identification number is matched to one of the plurality of stored identification numbers, (2) at least one of the entered second identification number is matched to one of the stored second identification numbers, the caller telephone number is matched to one of the stored telephone numbers and the voice sample is matched to one of the plurality of stored voice sample and (3) the entered identification number is associated with at least one of the one stored second identification number, the one stored telephone number and the one stored voice sample.

31. A system of voting by telephone utilizing multiple security levels, comprising:
a call receiving device adapted to receive a telephone call from a caller;
an identification number comparing device adapted to compare an entered identification number entered by the caller with a plurality of stored identification numbers;
one of:
a second identification number comparing device adapted to compare an entered second identification number entered by the caller to a plurality of stored second identification numbers;
a caller telephone number comparing device adapted to compare a caller telephone number to a plurality of stored telephone numbers;
a voice sample comparing device adapted to compare a voice sample provided by the caller to a plurality of stored voice samples; and
a voting device adapted to record a vote of the caller after (1) the entered identification number is matched to one of the plurality of stored identification numbers, (2) at least one of the entered second identification number is matched to one of the plurality of stored second identification numbers, the caller telephone number matches one of the plurality of stored telephone numbers and the voice sample matches one of the plurality of stored telephone numbers and (3) the entered identification number is associated with at least one of the one stored second identification number, the one stored telephone number and the one stored voice sample.

32. A closed telephone voting system utilizing multiple security levels, the closed telephone voting system comprising:
a input device adapted to allow a caller to input information;
at least one of:
an identification number comparing device adapted to compare an entered identification number entered by the caller to a plurality of stored identification numbers;
a second identification number comparing device adapted to compare an entered second identification number to a plurality of stored second identification numbers;
a voice sample comparing device adapted compare a voice sample provided by the caller to a plurality of stored voice samples; and
a voting device adapted to record a vote of the caller after at least one of (1) the entered identification number is matched to one of the plurality of stored identification numbers, (2) the entered second identification number is matched to one of the plurality of stored identification numbers and (3) the voice sample is matched to one of the plurality of stored voice samples.

33. A telephone voting system utilizing multiple security levels comprising:
a telephone call receiving device adapted to receive a telephone call of a caller;
at least one of:
an identification number comparing device adapted to compare an entered identification number entered by the caller to a plurality of stored identification numbers;
a second identification number comparing device adapted to compare an entered second identification number to a plurality of stored second identification numbers;
a caller telephone number comparing device adapted to compare a caller telephone number to a plurality of stored telephone numbers;
a voice sample comparing device adapted compare a voice sample provided by the caller to a plurality of stored voice samples; and
a voting device adapted to record a vote of the caller after at least one of (1) the entered identification number is matched to one of the plurality of stored identification numbers, (2) the entered second identification number is matched to one of the plurality of stored identification numbers, (3) the caller telephone number is matched to one of the plurality of stored telephone numbers and (4) the voice sample is matched to one of the plurality of stored voice samples.

34. A program storage medium, readable by a machine, embodying a program of instructions executable by the machine to perform method steps for voting by telephone using multiple security levels, the method steps comprising:
(a) receiving a telephone call from a caller;
(b) receiving an identification number entered by the caller;
(c) comparing the entered identification number to a plurality of stored identification numbers;
(d) comparing a telephone number from which the call originates, that is a caller telephone number, to a stored telephone number; and
(e) recording a vote entered by the caller if the entered identification number matches one of the plurality of stored identification numbers in step (c), the caller telephone number matches the stored telephone number in step (d) and the entered identification number and the stored telephone number are associated.

35. A computer system comprising:
a processor;
a program storage device readable by the computer system, embodying a program of instructions executable by the processor to perform method steps for voting by telephone, the method steps comprising:
(a) receiving a telephone call from a caller;
(b) receiving an identification number entered by the caller;
(c) comparing the entered identification number to a plurality of stored identification numbers;
(d) comparing the telephone number from which the call originates, that is a caller telephone number to a stored telephone number; and
(e) recording a vote entered by the caller if the entered identification number matches one of the plurality of stored identification numbers in step (c), the caller telephone number matches the stored telephone number in step (d) and the entered identification number and the stored telephone number are associated.
